(19) United States
(12) Patent Application Publication
(10) Pub. No.: US 2023/0415245 A1
(43) Pub. Date: Dec. 28, 2023

(54) APPLICATION APPARATUS WITH INTEGRATED DRILLING UNIT

(71) Applicants: thyssenkrupp Automotive Body Solutions GmbH, Heilbronn (DE); thyssenkrupp AG, Essen (DE)

(72) Inventor: Christoph SIEBENBORN, Losheim am See (DE)

(73) Assignees: thyssenkrupp Automotive Body Solutions GmbH, Heilbronn (DE); thyssenkrupp AG, Essen (DE)

(21) Appl. No.: 18/213,703

(22) Filed: Jun. 23, 2023

(30) Foreign Application Priority Data
Jun. 24, 2022 (DE) 10 2022 206 368.6

(51) Int. Cl. B23B 51/00

(52) U.S. Cl. CPC B23B 51/0002

(57) ABSTRACT

The present disclosure relates to an application apparatus for applying a sealing profile to a body component, including a roller head which is configured to, as a first station step, apply the sealing profile to a receiving surface of the body component, and comprising a drilling unit having a drill bit, wherein the drilling unit is configured to, as further station step, drill holes into the sealing profile by means of the drill bit.

### CROSS REFERENCE TO RELATED APPLICATION

This application is a U.S. Non-Provisional that claims priority to German Patent Application No. DE 10 2022 206 368.6, filed Jun. 24, 2022, the entire content of which is incorporated herein by reference.

### FIELD

The disclosure generally relates to an application apparatus for applying a sealing profile to a body component, and more specifically where the application apparatus includes a roller head which is configured to, as a first station step, apply the sealing profile to a receiving surface of the body component.

### BACKGROUND

Sealing profiles are applied, for example, to a body component serving to close a body opening, in particular in order to produce a sealing connection between a body opening and a cover inserted into the opening. Such a cover may for example be a door, a boot lid or a sliding roof element.

DE 10 2017 221 018 B3 has disclosed an application apparatus for applying a sealing profile to a body component, wherein the application apparatus comprises a cleaning apparatus. In this case, a surface region of the body component is defined as joining site for application of the sealing profile, said surface region also being called receiving surface. This surface region is then mechanically cleaned prior to the application of the sealing profile, in order to draw up any dust and to remove and take up any lubricant residues from the body component. A glued-on sealing profile adheres to the surface region more reliably when said surface region has been cleaned than when cleaning is omitted. Such an application apparatus in this case forms a manufacturing station.

Furthermore, it is known that the sealing profile may have holes, through which for example condensation which has accumulated under the sealing profile can escape. In this case, such holes are usually introduced into the sealing profile in a separate manufacturing station after the sealing profile has been applied, said manufacturing station generally being completely spatially separated from the application apparatus. Such a further manufacturing station thus requires corresponding space conditions. This is additionally associated with not insignificant costs, because, depending on the configuration of the manufacturing station, for example an additional robot and additional safety technology are required.

a need exists to provide an improved application apparatus, which in particular allows method steps associated with the sealing profile and/or the application of the sealing profile to be carried out with a reduced expenditure of time and advantageously with a reduced space requirement. Advantageously, the application apparatus is also intended to be able to meet different requirements in a cost-effective manner.

### BRIEF DESCRIPTION OF THE FIGURES

Further advantageous details, features and design details of the disclosure are explained in more detail in conjunction with the exemplary embodiments illustrated in the figures, in which:

FIG. 1 shows a perspective view of an embodiment of an application apparatus according to the disclosure.

FIG. 2 shows a perspective view of a further embodiment of an application apparatus configured according to the disclosure.

FIG. 3 shows a further perspective view of an embodiment of a base body for a configuration of an application apparatus according to the disclosure.

FIGS. 4a, 4b show perspective views of an embodiment of a drilling unit of an application apparatus according to the disclosure.

FIGS. 5a, 5b show a perspective view and a side view of a further embodiment of a drilling unit as functional module of an application apparatus according to the disclosure.

FIGS. 6a, 6b show perspective views of an embodiment of a cleaning unit as functional module.

FIGS. 7a, 7b show perspective views of an embodiment of a sensor unit for checking a position of a body component in space as functional module.

FIGS. 8a, 8b shows perspective views of an embodiment of a sensor unit for checking the position of the sealing profile applied to a body component as functional module.

FIGS. 9a, 9b shows perspective views of an embodiment of a sensor unit for checking a pressing force as functional module.

FIGS. 10a, 10b shows perspective views of an embodiment of a sensor unit for measuring a sealing profile length as functional module.

FIGS. 11a, 11b shows perspective views of an embodiment of a sensor unit for measuring a floating position of a pressing unit as functional module.

FIG. 12 shows a perspective view of a further embodiment of an application apparatus according to the disclosure with a movable robot arm.

FIG. 13 shows a perspective view of a further embodiment of an application apparatus according to the disclosure with a mount arranged in a stationary manner.

FIG. 14 shows a perspective view of a further embodiment of an application apparatus configured according to the disclosure with an arrangement interface comprised by the base body.

FIG. 15 shows a perspective view of an embodiment of a robot arm with a counterpart for connection to the arrangement interface of an application apparatus according to the disclosure.

FIG. 16 shows a perspective view of an embodiment of a stationary mount with a counterpart for connection to the arrangement interface of an application apparatus according to the disclosure.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The proposed solution provides an application apparatus for applying a sealing profile to a body component, in particular a body component serving to close a body opening, wherein the application apparatus comprises a roller head which is configured to, as a first station step, apply the sealing profile to a receiving surface of the body component, and a drilling unit having a drill bit, wherein the drilling unit is configured to, as further station step, drill holes into the sealing profile by means of the drill bit. Advantageously, in the case of an application apparatus designed in this way, it is thus possible for a sealing profile without previously introduced holes to be used and the provision of corresponding holes in the already fully applied sealing profile does not have to be effected in another processing station. Thus, a process step for which an additional processing station is usually provided is advantageously omitted. This additional processing station, which usually even requires a dedicated robot, and the space requirement necessary for this additional processing station are thus advantageously omitted.

The drilling unit in particular comprises a drill bit and a drive unit in order to set the drill bit in rotation. As drive unit, in particular an electric motor is provided. The drill bit can advantageously be exchanged. In particular, as one configuration provision may be made for the drilling unit to be able to be equipped with different drill bits, in particular to be able to be equipped with different drill bits in an automated manner.

In particular, an application apparatus for applying a sealing profile to a body component is proposed, wherein the application apparatus comprises a roller head and at least one further functional unit. The roller head is in this case configured to, as a first station step, apply the sealing profile to a receiving surface of the body component, and the further functional unit is in each case configured to carry out a further station step associated with the sealing profile and/or the application of the sealing profile. The at least one further functional unit is in each case configured as a functional module from a quantity of functional modules, wherein the quantity may in particular also comprise exactly one functional unit. In this case, one of the functional units is the drilling unit which is configured to drill holes into the sealing profile. Advantageously, provision is additionally made for the application apparatus to have a base body, wherein the base body has the roller head and a plurality of predetermined arrangement positions. In this case, a specific arrangement position from the plurality of predetermined arrangement positions is in each case assigned a functional module from the quantity of functional modules for arrangement on the base body, wherein each functional module of the application apparatus is arranged at the arrangement position assigned to the respective functional module. Since the described functional units of the application apparatus are configured as functional modules, the terms functional unit and functional module are also used interchangeably in the following description. The base body advantageously always comprises the same number of arrangement positions, in particular independently of how many functional modules are ultimately arranged on the base body. Thus, a wide variety of different configuration variants of the application apparatus can advantageously be implemented in particular using the same base body. The location at which a respective functional unit is arranged on the base body is in this case advantageously predefined by the arrangement of the arrangement positions on the base body. In particular, a functional unit may also comprise a plurality of functional components, which are then in particular arranged at arrangement positions specifically assigned to these functional components. The sum of these arrangement positions is then in particular the arrangement position assigned to the functional unit.

The respective arrangement position on the base body of the application apparatus advantageously also defines the order in which a work step or a station step is carried out by the respective functional module, in particular is carried out in relation to the application of the sealing profile. In particular, the arrangement positions for the functional modules assigned to these arrangement positions are predetermined in such a way that a processing order of the respective further station step which can be carried out by the respective assigned functional module is defined in relation to the first station step. It is pointed out in this context that the designation “first station step” serves only to differentiate further station steps and does not define an order. In particular, the “first station step” does not have to be the station step which is carried out first.

According to an advantageous configuration of the application apparatus, the base body also has a plurality of arrangement positions for the same functional module, in particular two or three arrangement positions, wherein, depending on the arrangement position at which the functional module is arranged, it is advantageously also defined whether the functional module carries out the associated station step prior to or during or after the application of the sealing profile.

Since it is thus advantageously possible to construct different application apparatuses with integrated drilling unit based on the same base body, in particular application apparatuses which differ with regard to the range of functions and/or with regard to the execution of station steps, the application apparatus can also meet different requirements in a cost-effective manner. In particular, the application apparatus is in this case assigned to a single manufacturing station. In this respect, the application apparatus advantageously also occupies only the space required for a single manufacturing station. In this respect, the application apparatus in particular does not comprise a plurality of manufacturing stations which are merely structurally connected to one another, with the application of the sealing profile being assigned to the one manufacturing station and the further function being assigned to the further manufacturing station.

A further advantageous configuration of the application apparatus provides for the drilling unit to be assigned to an arrangement position, in particular to an arrangement position on a base body of the application apparatus, wherein the arrangement position defines a drilling of the sealing profile as further station step prior to an application of the sealing profile. In this case, provision is in particular made for the holes to be introduced into the sealing profile before the sealing profile is fed to a storage unit from which the sealing profile is provided for the application of the sealing profile.

According to a preferred configuration variant, provision is conversely made for the drilling unit to be assigned to an arrangement position, in particular to an arrangement position on a base body of the application apparatus, wherein the arrangement position defines a drilling of the sealing profile as further station step during an application of the sealing profile. This configuration advantageously allows holes to be introduced into the sealing profile without any loss of cycle time. A drilling of the sealing profile during an application of the sealing profile in particular does not mean that the holes are introduced into a sealing profile portion which is currently being applied to a body component. Instead, provision is advantageously made in this configuration variant for the drilling of holes into a first portion of the sealing profile and the application of a second portion of the sealing profile to be effected at the same time, wherein the drilling unit is in particular located downstream of the roller head, such that holes are drilled into the first portion of the sealing profile and said first portion is then applied to a body component by the roller head at a later point in time.

In a further configuration variant, the drilling unit is assigned to an arrangement position which defines a drilling of the sealing profile as further station step after an application of the sealing profile. In this case, the arrangement position is in particular an arrangement position on a base body of the application apparatus. This configuration variant is in particular provided if the application apparatus is robot-guided. In this case, the drilling unit is advantageously arranged on the base body in such a way that the drill bit points outwards and the drilling unit can introduce the holes into the sealing profile by a pivoting of the application apparatus after the sealing profile has been applied. However, the configuration variant may in particular also be provided if the application apparatus is arranged fixed on a stationary carrier, the component then in particular being correspondingly moved to the drill bit, in particular by means of a robot arm.

A further advantageous configuration provides for the application apparatus to be assigned a control unit, wherein the control unit is advantageously configured to control the roller head and the drilling unit. The control unit is in particular an electronic control unit, advantageously a PLC (PLC: programmable logic controller). The control unit is in this case advantageously configured to actuate the drilling unit for carrying out drilling operations. Advantageously, the control unit is also configured to actuate the roller head and the drilling unit in a coordinated manner, advantageously in order for a drilling and an application to be able to be carried out so as to be harmonized with one another in a targeted manner. Provision is in particular made for the control unit to stop the application for the duration of the drilling. Thus, while the bores are being created at predefined positions by actuation of the drilling unit by means of the control unit, advantageously no application is effected.

According to a further advantageous configuration, the drill bit of the drilling unit is oriented along a drilling axis, wherein the drilling axis of the drill bit can be adjusted by means of an actuator unit of the application apparatus, in particular an actuator unit of the drilling unit. The drilling unit is thus advantageously configured in such a way that the drill bit of the drilling unit can have different angles of inclination at which a drilling operation is carried out. In particular, the drilling unit and/or the drill head receiving the drill bit are/is of correspondingly adjustable configuration. For an automatic adjustment, the drilling unit advantageously comprises at least one actuator unit by means of which the drilling unit and/or the drill head can be adjusted relative to the base body of the application apparatus. As a result of this adjustment possibility of the drilling axis, the orientation of the drill holes can advantageously be set according to a predefined specification. Provision is in particular made for the drilling axis of the drill bit to be able to be adjusted in a first spatial direction and/or in a second spatial direction and/or in a third spatial direction.

Further advantageously, the drilling unit comprises a suction-removal unit which is configured for suction removal of chips produced during the drilling of the sealing profile. In particular, the suction-removal unit comprises a suction-removal hood. In this way, a situation in which chips adhere to the body component during the further processing, said chips in particular possibly having a negative effect on the further processing, is advantageously avoided.

A further advantageous configuration provides for the drilling unit to comprise at least one sensor unit which is advantageously configured to monitor a drilling operation carried out by the drill bit of the drilling unit. In this case, the sensor unit may comprise one or more sensors. In particular, at least one evaluation unit is provided, which receives and evaluates the data acquired by the sensors of the sensor units. Further advantageously, the evaluation unit is configured to process the data acquired by the sensor or the sensors of this sensor unit, in particular to store the data and/or to evaluate the data and/or to prepare for a visualization of the data. Provision is in particular made for the position of the holes drilled into the sealing profile to be able to be detected and stored by means of this sensor unit during the drilling. Advantageously, the sensor unit can be used to analyse the data acquired in this regard and preferably to prepare it for a visualization by means of an image display device, in particular by means of an external image display device. In particular, the thus prepared data is displayed on an image display device. Advantageously, this sensor unit is also configured for statistical evaluation of the acquired data, in particular for statistical evaluation of the acquired data for process monitoring.

According to a further advantageous configuration, provision is made for the application apparatus to comprise an arrangement interface by way of which the application apparatus is arranged on a movable robot arm or on a station carrier. The arrangement interface thus advantageously makes the application apparatus usable in an even more flexible manner, namely in particular as a stationary application apparatus, wherein a body component for processing is guided along the application apparatus in a suitable manner, and in particular as a mobile, robot-guided application apparatus which is guided in a suitable manner along a body component for processing. Advantageously, the base body of the application apparatus has the arrangement interface.

In particular, provision is in this case made according to one configuration variant for the base body of the application apparatus to be arranged on a station carrier by way of the arrangement interface. As arrangement on a station carrier, a mount of the application apparatus is in particular provided, such that the roller head of the application apparatus is in particular a mounted roller head with integrated drilling unit. Further advantageously, provision is made according to a further configuration variant for the base body of the application apparatus to be arranged on a movable robot arm by way of the arrangement interface. As a result of the arrangement on a movable robot arm, the application apparatus is advantageously robot-guided and thus in particular the roller head of the application apparatus is also a robot-guided roller head with an integrated drilling unit.

The base body of the application apparatus is in particular at least partially composed of a metallic material, more particularly completely composed of a metallic material. In particular, aluminium and/or steel are provided as material. However, other materials of which the base body may consist are in particular also conceivable. The base body may in particular be configured in one piece or multiple pieces.

According to a further advantageous configuration, the application apparatus comprises a cleaning unit as further functional unit, wherein the cleaning unit is in particular configured to clean a receiving surface of a body component, in particular the receiving surface to which the sealing profile is intended to be subsequently applied. In this case, the cleaning is intended to remove in particular residues, in particular wax residues, which could prevent reliable substance-to-substance bonding of the sealing profile to the body component. Advantageously, as a result of the cleaning unit, a separate cleaning station together with associated robot and associated station demarcation is omitted.

Provision is in particular made for the cleaning unit to be assigned to an arrangement position which defines a cleaning of a receiving surface of the body component as further station step prior to an application of the sealing profile. This configuration variant is in particular provided if the application apparatus is robot-guided. In this case, the cleaning unit is advantageously arranged on the base body in such a way that a cleaning roll of the cleaning unit points outwards and the cleaning roll is moved along relative to the receiving surface to be cleaned. However, this configuration variant may in particular also be provided if the application apparatus is arranged fixed on a stationary carrier, the component then in particular being correspondingly moved relative to the cleaning unit, in particular by means of a robot arm.

In an advantageous configuration variant, the cleaning unit is assigned to an arrangement position which defines a cleaning of a receiving surface of a body component as further station step during an application of the sealing profile. This configuration advantageously allows the receiving surface to be cleaned without any loss of cycle time. In this case, a cleaning of the receiving surface during an application of the sealing profile means that, in this configuration variant, the cleaning of a first portion of the receiving surface and the application of the sealing profile in a second, already previously cleaned portion are effected at the same time, wherein in particular the cleaning unit is located upstream of the roller head. It is understood that, in this configuration, it is in particular provided that at a beginning of a processing of a body component, a cleaning is initially effected without a simultaneous application for a brief period, and at an end of a processing, an application is in particular effected without a simultaneous cleaning for a period.

Provision is in particular made for the cleaning unit to comprise a plurality of cleaning components which are arranged at different arrangement positions predefined therefor. As cleaning components, the cleaning unit advantageously comprises the following components individually or in possible combinations: a cleaning belt, in particular a cleaning fleece; a cleaning roll via which the cleaning belt is advantageously guided for cleaning of the receiving surface; an unwinding roll from which clean cleaning belt is provided; a winding-up roll by which cleaning belt used for cleaning is received; at least one drive unit, in particular at least one electrical drive unit with corresponding connections and lines, more particularly drives for the unwinding roll and the winding-up roll, more particularly a drive for a lateral movement travel of the cleaning roll; a carriage, in particular a carriage for a lateral movement travel of the cleaning roll; a pressing cylinder for pressing the cleaning roll; at least one sensor unit; at least one fastening element.

Further advantageously, the application apparatus comprises at least one sensor unit as at least one further functional unit, wherein the sensor unit is in particular configured to monitor an execution of a station step. In particular, a plurality of sensor units are provided, which may each constitute a functional unit. However, sensor units may also be provided as supplementary component to a functional unit. The respective sensor unit is advantageously assigned to an arrangement position which defines a monitoring of an execution of a station step as further station step during an execution of the station step to be monitored, such that it is in particular possible to react immediately if a station step is not being carried out as predefined. As an alternative or in addition, provision is made for the respective sensor unit to be assigned to an arrangement position which defines a monitoring of an execution of a station step as further station step after an execution of the station step to be monitored. In particular, at least one evaluation unit is provided, which receives and evaluates the data acquired by the sensors of the sensor units. In this case, it is in particular possible to provide a central evaluation unit for all the sensor units. However, provision is in particular also made for at least some of the sensor units to comprise a respective evaluation unit.

An advantageous configuration provides a camera unit as sensor unit, wherein the camera unit may in particular comprise a plurality of cameras. In particular, the camera is a smart camera. The camera unit advantageously comprises an evaluation unit for evaluating the acquired image data. The camera unit is advantageously configured to identify the spatial position of the component to which the sealing profile is intended to be applied, in particular the spatial position of the component in relation to the application apparatus, in particular if the component is received in what is referred to as a hanger. Advantageously, the camera unit allows the position of the component in space to be determined during the rolling-on in the hanger. Advantageously, the evaluation unit provides correction values which are derived from this data and which are in particular transmitted to a robot controller for the robot on which the application apparatus is arranged.

According to a further advantageous configuration, the application apparatus comprises, as sensor unit, a sensor unit for checking the position of the sealing profile applied to a body component. Provision is in particular made for this sensor unit to comprise a laser profile sensor. Further advantageously, this sensor unit comprises an evaluation unit for processing the data acquired by the sensor of this sensor unit, in particular for storing the data and/or for evaluating the data and/or for preparing for a visualization of the data. Provision is in particular made for the position of the sealing profile applied to the receiving surface of the body component relative to the body component to be able to be detected and stored by means of this sensor unit during the application. Advantageously, the sensor unit can be used to analyse the data acquired in this regard and preferably to prepare it for a visualization by means of an image display device, in particular by means of an external image display device. In particular, the thus prepared data is displayed on an image display device. Advantageously, this sensor unit is also configured for statistical evaluation of the acquired data, in particular for statistical evaluation of the acquired data for process monitoring.

As a further advantageous configuration, provision is made for the application apparatus to comprise, as sensor unit, a sensor unit for checking a pressing force, in particular a sensor unit for checking a pressing force during an application of a sealing profile to a receiving surface of a body component. Provision is in particular made for this sensor unit to be configured to check the pressing force of a pressing unit of the roller head, in particular of a pressing roll as pressing unit, wherein the sealing profile is advantageously guided by way of the pressing unit. Provision is in particular made for this sensor unit to comprise a load pin for this purpose. Further advantageously, this sensor unit comprises an evaluation unit for processing the data acquired by the sensor of this sensor unit, in particular for storing the data and/or for evaluating the data and/or for preparing for a visualization of the data. Provision is in particular made for the pressing force with which the sealing profile is applied to the receiving surface of the body component to be able to be detected and stored by means of this sensor unit during the application. Advantageously, the sensor unit can be used to analyse the data acquired in this regard and preferably to prepare it for a visualization by means of an image display device, in particular by means of an external image display device. In particular, the thus prepared data is displayed on an image display device. Advantageously, this sensor unit is also configured for statistical evaluation of the acquired data, in particular for statistical evaluation of the acquired data for process monitoring.

A further advantageous configuration provides for the application apparatus to comprise, as sensor unit, a sensor unit for measuring a sealing profile length which a sealing profile to be applied to a receiving surface of a body component is intended to have. Since the sealing profile is provided in particular in the form of an endless profile, it is advantageously possible for this sensor unit to be used to determine the predefined length of the sealing profile for a predefined body component and to thus sever the sealing profile at the correct location. Provision is in particular made for this sensor unit to comprise a measuring wheel, in particular a toothed wheel and/or a friction wheel as measuring wheel. Further advantageously, this sensor unit comprises a rotary encoder. Further advantageously, this sensor unit comprises an evaluation unit for processing the data acquired by the sensor of this sensor unit, in particular for storing the data and/or for evaluating the data and/or for preparing for a visualization of the data. Provision is in particular made for the sealing length of the sealing profile applied to the receiving surface of the body component to be able to be detected and stored by means of this sensor unit during the application. Advantageously, the sensor unit can be used to analyse the data acquired in this regard and preferably to prepare it for a visualization by means of an image display device, in particular by means of an external image display device. In particular, the thus prepared data is displayed on an image display device. Advantageously, this sensor unit is also configured for statistical evaluation of the acquired data, in particular for statistical evaluation of the acquired data for process monitoring. In particular, it is thus possible for a strain profile to be reproducibly documented for process control and error analysis. In addition, this sensor unit advantageously permanently controls the fill level of a storage unit, in particular of a sealing magazine which stores the endless sealing profile. The consumption of the sealing profile is also advantageously documented by this sensor unit.

According to a further advantageous configuration, provision is made for the application apparatus to have, as sensor unit, a sensor unit for measuring a floating position of a pressing unit of the application apparatus. In this case, the pressing unit is in particular a pressing roll. Provision is in particular made for this sensor unit to comprise a laser distance sensor. Advantageously, a shifting plate is also arranged on the pressing unit, the laser of the laser distance sensor advantageously being oriented on said shifting plate. Further advantageously, this sensor unit comprises an evaluation unit for processing the data acquired by the sensor of this sensor unit, in particular for storing the data and/or for evaluating the data and/or for preparing for a visualization of the data. Provision is in particular made for the position of the pressing unit to be able to be detected and stored by means of this sensor unit during the application. Advantageously, the sensor unit can be used to analyse the data acquired in this regard and preferably to prepare it for a visualization by means of an image display device, in particular by means of an external image display device. In particular, the thus prepared data is displayed on an image display device. Advantageously, this sensor unit is also configured for statistical evaluation of the acquired data, in particular for statistical evaluation of the acquired data for process monitoring. In particular, an improved pressing force regulation is implemented by means of this sensor unit. Further advantageously, this sensor unit makes it possible to prevent the end positions of the movably mounted pressing unit from being reached. Advantageously, it is thus possible to prevent damage to the application apparatus and/or to the workpiece to be processed.

A further advantageous configuration of the application apparatus provides a separating unit as further functional unit, wherein the separating unit is configured to sever a sealing profile. In particular, the separating unit comprises at least one cutting blade for severing the sealing profile. The separating unit is advantageously configured to shorten an endless sealing profile to the respective sealing profile length required for a predetermined body component, in particular at the end of an application operation for a component. Advantageously, the separating unit is controlled by the sensor unit for measuring a sealing profile length.

In particular, the separating unit is assigned to an arrangement position on the base body of the application apparatus, said arrangement position defining a severing of a sealing profile as further station step during an application of the sealing profile. In this case, a severing of the sealing profile during an application of the sealing profile means that, in this configuration variant, the severing of the sealing profile and the application of the sealing profile is effected at the same time at two different portions of the sealing profile, wherein in particular the separating unit is located downstream of the roller head. In this case, a severed end of a sealing profile is applied to the receiving surface of a body component at a later point in time.

Provision is further advantageously made for the base body of the application apparatus to have cable guides, in particular inlet and/or outlet openings, in particular cable guides for cables for the at least one further functional unit. Advantageously, the construction of the application apparatus is further simplified as a result and thus cost-effective. Provision is in particular made for arrangement positions and/or cable guides for a determined functional unit to be marked in a particular manner on the base body, in particular to be marked in colour. This advantageously simplifies the assignment of the respective functional module to the respective arrangement position. As an alternative or in addition, provision is made for arrangement locations of functional components of one functional module to be differentiated from the arrangement locations of functional components of another functional module, such that it is advantageously technically ensured that the functional modules can be arranged only at arrangement positions provided therefor.

A modular kit, proposed in supplementary fashion, for the construction of an application apparatus comprises a multiplicity of modules with predefined properties, wherein an application apparatus can be constructed from the modules in different configuration variants. Advantageously, no adaptation of the modules is required for this. In particular, the kit comprises basic modules, which should always be used for the construction of an application apparatus, and expansion modules, which should optionally be used for the construction of an application apparatus. The basic modules advantageously comprise a base body, a roller head and a drilling unit. The expansion modules advantageously comprise a cleaning unit, at least one sensor unit and a separating unit. In particular, further basic modules and/or further expansion modules may also be provided. In this respect, an application apparatus constructed based on the modular kit always comprises the base modules of the kit. An application apparatus constructed based on the modular kit can comprise a number of the expansion modules which is adapted depending on requirements, wherein in particular also no expansion modules or one expansion module or all the expansion modules of the kit may be comprised by the application apparatus. Due to the modular construction, a high flexibility is advantageously realized, the effort and thus the costs for the individualization advantageously being low.

Provision is in particular made for the basic modules and the expansion modules to be configured for the construction of an application apparatus configured according to the disclosure, and it is thus in particular possible to construct an application apparatus which has the above-described features individually or in combination. In particular, the base body of the kit has the above-described features of the base body of the application apparatus individually or in combination. The expansion modules of the kit advantageously have the above-described features of the functional units or of the functional modules of the application apparatus individually or in combination.

In the various figures, identical parts are generally provided with the same reference signs and are therefore also, in some cases, each explained only in conjunction with one of the figures.

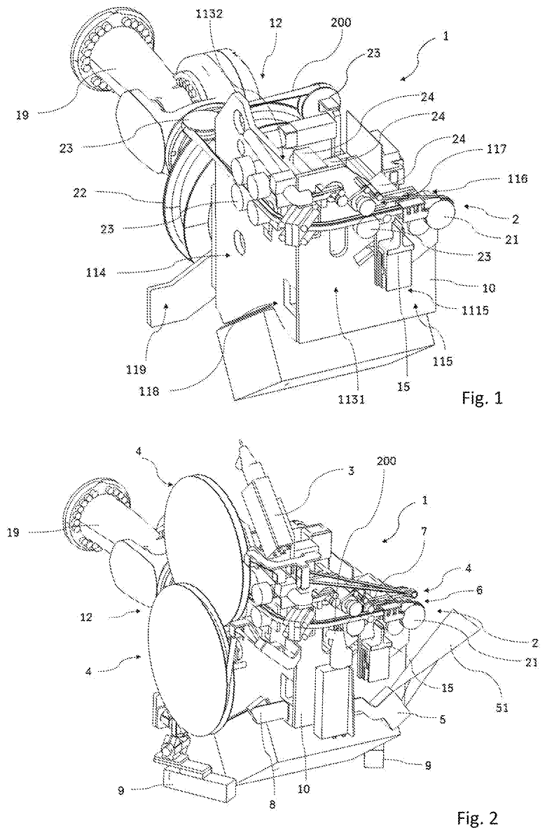

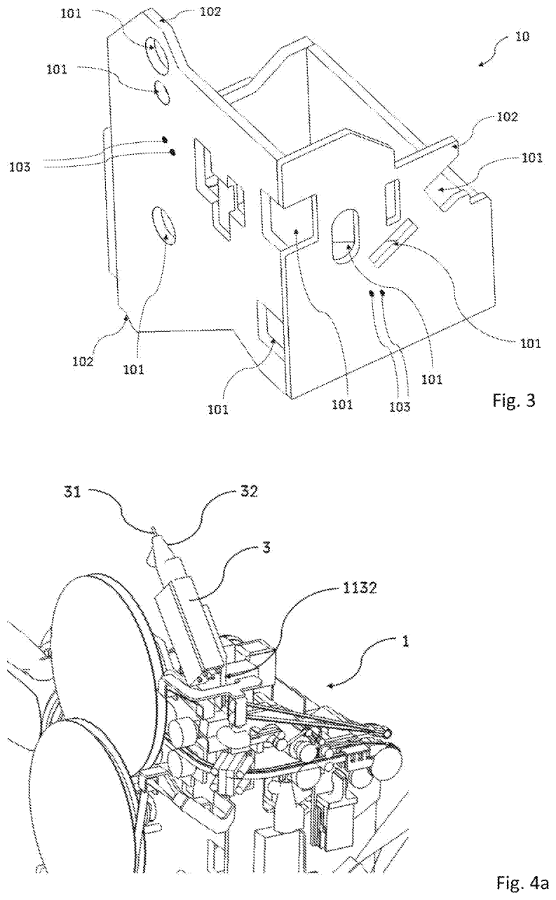

FIG. 1 illustrates an exemplary embodiment of an application apparatus 1 which is configured to apply a sealing profile 200 to a body component. The application apparatus 1 has a base body which may be formed in particular from aluminium sheet. FIG. 3 shows an advantageous configuration of the base body 10.

Arranged on the base body 10 is a roller head 2 which is configured to, as a first station step, apply the sealing profile 200 to a receiving surface of a body component. In this case, the roller head 2 comprises a multiplicity of components, in particular a storage unit 22 which provides the sealing profile 200 in the form of an endless profile, various rolls 23 for guiding the sealing profile 200, drive units 24 for driving rolls 23 for conveyance of the sealing profile 200 and a pressing unit 21 by means of which the sealing profile 200 is pressed onto the receiving surface.

Moreover, in addition to the roller head 2, a separating unit 15 is arranged as further functional unit on the base body 10. In this case, the separating unit 15 is configured as a functional module and comprises a knife blade by means of which the sealing profile 200 can be severed, such that the sealing profile 200 has exactly the length intended for the respective body component. In particular, the separating unit 15 comprises an actuator unit which can be actuated for a severing of the sealing profile 200. The separating unit 15 is arranged at a predefined arrangement position 1115 of the base body 10 in relation to the roller head 2 in such a way that the severing of the sealing profile 200 is defined as further station step during an application of the sealing profile 200. That is to say that while the sealing profile 200 is being applied to the receiving surface of the body component by means of the roller head 2, the sealing profile 200 is severed by means of the separating unit 15 at a suitable point in time.

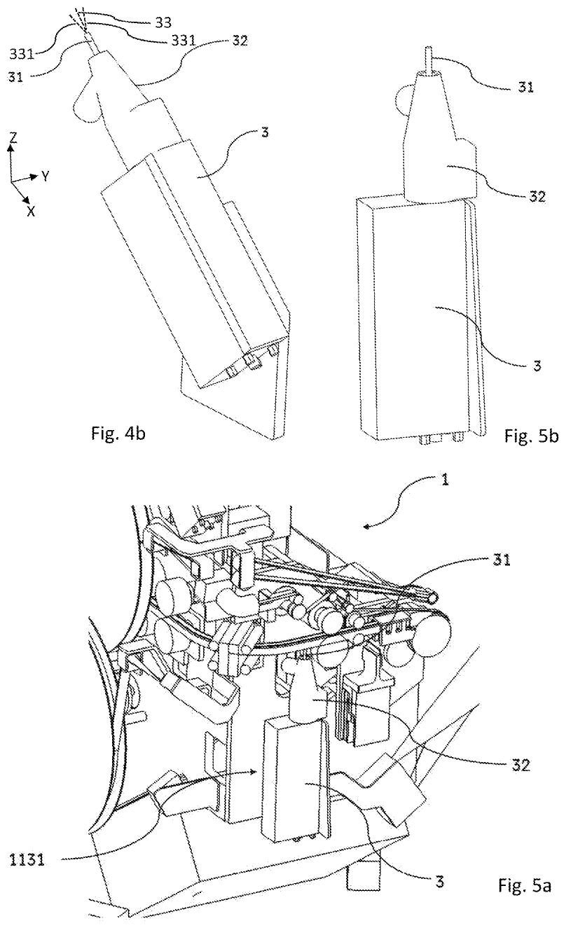

The base body 10 of the application apparatus 1 also has a plurality of further predetermined arrangement positions 11, wherein a specific arrangement position 11# from the plurality of predetermined arrangement positions 11 is assigned to a respective further functional module which may also be arranged on the base body 10. In this exemplary embodiment, the base body has a plurality of possible arrangement positions for the arrangement of a drilling unit 3 provided according to the disclosure. In this case, the drilling unit 3 is advantageously designed, as illustrated in FIG. 4b or FIG. 5b, and arranged on the application apparatus 1, as illustrated in FIG. 4a or FIG. 5a, respectively. The drilling unit 3 is not explicitly illustrated in FIG. 1, but rather only the preparation of the application apparatus 1 for arrangement of the drilling unit 3. The base body 10 of the application apparatus 1 thus has an arrangement position 1131 for the drilling unit 3, this arrangement position 1131 allowing holes to be drilled into the sealing profile 200 by means of the drilling unit 3 during the application of the sealing profile 200. In addition, the base body 10 alternatively has an alternative arrangement position 1132 for the drilling unit 3, this arrangement position 1132 allowing holes to be drilled into the already applied sealing profile 200 by means of the drilling unit 3, that is to say allowing holes to be drilled after the application of the sealing profile 200. Advantageously, the drill bit of the drilling unit 3 can in this case be oriented differently, such that a fine positioning of the drill bit of the drilling unit 3 is made possible by way of the drilling unit 3. Advantageously, it is thus also possible to predefine different angles of inclination for the holes.

In this exemplary embodiment, the base body 10 furthermore comprises an arrangement interface 12, which faces away from the viewer in the illustration in FIG. 1. An advantageous configuration of the arrangement interface 12 is explained in more detail with reference to FIG. 14 to FIG. 16. In the exemplary embodiment illustrated in FIG. 1, the base body 10 is arranged on a movable robot arm 19 by way of the arrangement interface 12. By means of the robot arm 19, the roller head 2 can thus be guided along the receiving surface of a body component so as to apply the sealing profile 200 to the body component, which may for example be arranged in a hanger. In addition, by means of the robot arm 19, the drill bit 31 of the drilling unit 3 can be guided along the receiving surface of the body component so as to drill the holes into the applied sealing profile 200.

Furthermore, the base body 10 has arrangement positions 114 for a cleaning unit 4 by means of which the receiving surface for the sealing profile 200 can be cleaned prior to the application of the sealing profile. Furthermore, the base body 10 comprises arrangement positions 119 for a sensor unit 9 for checking a position of a body component in space, an arrangement position 115 for a sensor unit 5 for checking the position of the sealing profile 200 applied to a body component, an arrangement position 116 for a sensor unit 6 for checking a pressing force during an application of the sealing profile 200, an arrangement position 117 for a sensor unit 7 for measuring a sealing profile length during the application of the sealing profile 200 and an arrangement position 118 for a sensor unit 8 for measuring a floating position of the pressing unit 21.

FIG. 2 illustrates a further exemplary embodiment of an application apparatus 1 which is configured according to the disclosure and which has the same base body 10 as the application apparatus 1 according to FIG. 1, but with all the arrangement positions 11 having been equipped with the corresponding functional modules and the already mentioned drilling unit 3 also being illustrated. The illustration of the application apparatus 1 according to FIG. 2 thus comprises, in a supplementary manner to the illustration of the application apparatus 1 according to FIG. 1, the drilling module 3, a cleaning module 4 with components arranged at the corresponding arrangement positions 114, a sensor module 5 for checking the position of the sealing profile 200 applied to a body component, a sensor module 6 for checking a pressing force of the pressing unit 21, a sensor module 7 for measuring the sealing profile length, a sensor module 8 for measuring the floating position of the pressing unit 21 and a sensor module 9 for checking a position of a body component in space, wherein the sensor module 9 comprises two camera units which are arranged at the respective arrangement positions 119.

The respective arrangement positions 11# of the functional modules 3, 4, 5, 6, 7, 8, 9, 15 relative to one another advantageously define—at least to a certain extent—a processing order of the station step to be carried out by the respective functional module, in particular in relation to the application of the sealing profile as station step.

FIG. 3 shows an exemplary embodiment of the base body 10 of the application apparatuses 1 illustrated in FIG. 1 and FIG. 2. In this exemplary embodiment, the base body 10 comprises four metal plates, in particular aluminium plates, which are connected to one another at right angles, such that the base body 10 has a rectangular outline. In this case, the metal plates of the base body 10 are of different design, since these are adapted for the arrangement of the respective functional modules. In addition, the metal plates each have cutouts 101 and/or projections 102 and/or bores 103, which form the arrangement positions 11. In addition, the base body 10 may in particular also have bores for cable guides.

Various functional units 3, 4, 5, 6, 7, 8, 9 configured as functional modules, in particular for use with the application apparatus 1 illustrated in FIG. 1, are explained in more detail with reference to FIG. 4a to FIG. 11b, Figure #a in each case showing the respective functional module as constituent part of an application apparatus 1 configured according to the disclosure, and Figure #b in each case showing the respective functional module on its own.

The respective functional modules 3, 4, 5, 6, 7, 8, 9 may in particular also be a constituent part of a modular kit for the construction of an application apparatus 1, wherein the modular kit comprises a multiplicity of modules which have predefined properties and from which the application apparatus 1 can be constructed in different configuration variants. In this case, this modular kit advantageously comprises the base body 10, the roller head 2 and the drilling unit 3 as basic modules which are used for the construction of each application apparatus 1. By contrast, the functional modules 4, 5, 6, 7, 8, 9, 15 are advantageously expansion modules which can optionally be used individually or in any desired combination for the construction of an application apparatus, in particular depending on the client requirements. As a configuration variant, when using endless sealing profiles, provision is in particular made for the separating unit 15 to, as a divergence, not be an expansion module, but rather also a basic module that each application apparatus 1 comprises.

FIG. 4b shows an exemplary embodiment of a drilling unit 3 as functional module, wherein the drilling unit 3 comprises a drill bit 31 which can be driven by means of a drive unit and which is intended to drill holes into a sealing profile 200, and a suction-removal hood 32. The suction-removal hood 32 can advantageously be used for the suction removal of material residues produced during the drilling. The holes drilled into the sealing profile function, in particular, as water drainage holes in the later use of the body component in a motor vehicle. The drilling axis 33 of the drill bit 31 in the current orientation of the drill bit 31 is also shown symbolically as dashed lines in FIG. 4b. This drilling axis 33 can in this case be adjusted, in particular with respect to the angle of the drill bit 31, by means of an actuator unit which is not explicitly shown in FIG. 4b. FIG. 4b shows by way of example two drilling axes 331 with adjusted orientation. Provision is in particular made for the drilling axis 33 of the drill bit 31 to be able to be adjusted in a first spatial direction X and in a second spatial direction Y and/or in a third spatial direction Z.

FIG. 4a shows the drilling module 3 arranged on the base body 10 of an application apparatus 1 at a first arrangement position 1132, this arrangement position 1132 defining a drilling of the sealing profile 200 as further station step after an application of the sealing profile 200. The drilling unit 3 advantageously comprises actuator units, wherein the drill bit 31 of the drilling unit can be adjusted, preferably in all three spatial directions X, Y, Z, relative to the base body 10 of the application apparatus 1 by means of the actuator units. In particular, the drilling unit 3 may comprise a sensor unit which in this case monitors the drilling and advantageously the position of the drill bit 31 relative to the base body. In particular, the drill bit 31 of the drilling unit 3 is oriented along a drilling axis, wherein the drilling axis of the drill bit 31 can be correspondingly adjusted by means of the actuator units. The adjustment of the drill bit 31 is in this case controlled by a control unit which is not explicitly illustrated and which may in particular be in the form of a correspondingly configured microcontroller unit.

By contrast, FIG. 5a shows a further exemplary embodiment in which the drilling module 3 is arranged on the base body 10 of an application apparatus 1 at a second arrangement position 1131. This arrangement position 1131 permits a drilling of the sealing profile 200 as further station step during an application of the sealing profile 200. The drilling module 3 is illustrated in a side view in FIG. 5b.

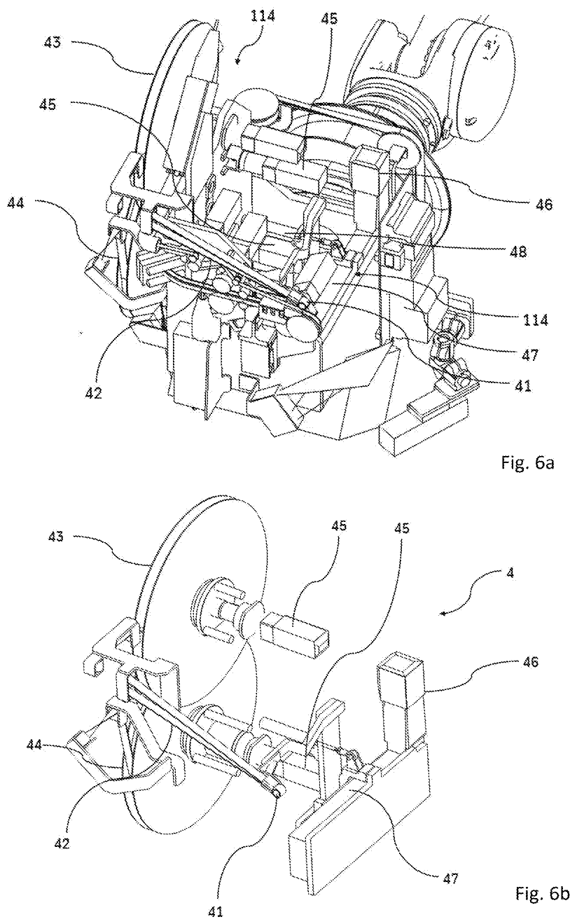

FIG. 6b illustrates an exemplary embodiment of a cleaning module 4 which is configured to clean the receiving surface of the body component to which the sealing profile 200 is intended to be applied. In the application apparatus 1 shown in FIG. 6a, the cleaning module 4 is arranged at an arrangement position 114 which is distributed among various regions of the base body 10, or, in other words, the components of the cleaning module 4 are arranged on the base body 10 at a plurality of arrangement positions 114. The arrangement position 114 or the arrangement positions 114 in this case permit a cleaning of a receiving surface of the body component as further station step by means of the cleaning module 4 during an application of the sealing profile 200. As components, in this exemplary embodiment the cleaning module 4 comprises a cleaning roll 41 via which a cleaning belt 42, in particular a cleaning fleece, is guided for cleaning of the receiving surface. The cleaning belt 42 is then provided as clean cleaning belt 42 from a roll 43, in particular an unwinding roll. Contaminated cleaning belt 42 which has already been used for cleaning is received by a roll 44, in particular a winding-up roll. In this case, the rolls 43, 44 are driven by a drive unit 45. In addition, the cleaning module 4 comprises, as further components, a carriage 47 by means of which a lateral movement travel of the cleaning roll 41 can be realized, wherein the carriage 47 is driven by a further drive unit 46. In addition, the cleaning module 4 comprises a pressing cylinder 48 by means of which the cleaning roll 41 is pressed against the receiving surface to be cleaned.

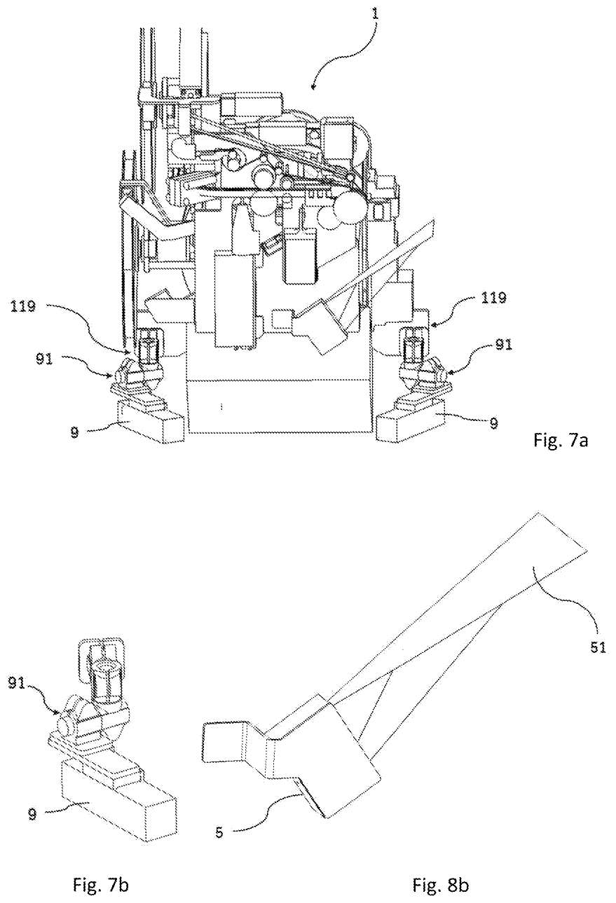

FIG. 7b shows an exemplary embodiment of a sensor unit 9 for checking a position of a body component in space. In this exemplary embodiment, the sensor unit 9 comprises two camera units held by adjustable holding apparatuses 91. In this case, FIG. 7a illustrates how the sensor unit 9 with the holding apparatuses 91 is arranged at the arrangement positions 119 of the base body 10 of an application apparatus 1. The sensor unit 9 is in particular advantageous if the application apparatus 1 is guided by a robot 19 for the application of the sealing profile 200, wherein the sensor unit 9 in this case advantageously provides data regarding the body component position to a control unit of the robot 19, such that a sealing profile 200 can advantageously be applied with high precision to the body component.

FIG. 8b shows an exemplary embodiment of a sensor unit 5 for checking the position of the sealing profile 200 applied to a body component, the sensor unit 5 being configured as a laser profile sensor in this exemplary embodiment. FIG. 8a illustrates an application apparatus 1 with the sensor unit 5, wherein the sensor unit is arranged at the arrangement position 115 of the base body 10 of the application apparatus 1, said arrangement position being provided therefor. The arrangement position 115 and the orientation of the sensor unit 5 is in this case determined such that a detection region 51 of the sensor unit 5 is oriented in such a way that the position of the sealing profile 200 relative to the body component can be detected and stored during the application of the sealing profile 200. The corresponding data can then advantageously be analysed directly, such that process monitoring is implemented with only a small time delay with respect to the application operation. In particular, it is thus possible to monitor whether the sealing profile 200 has been placed on the receiving surface of the body component within permissible tolerances. If a deviation of the position of the sealing profile 200 from predefined setpoint values were to be identified, a warning signal is advantageously generated. Advantageously, this sensor unit 5 can alternatively or additionally be used to check the positions of the drill holes drilled into the sealing profile 200.

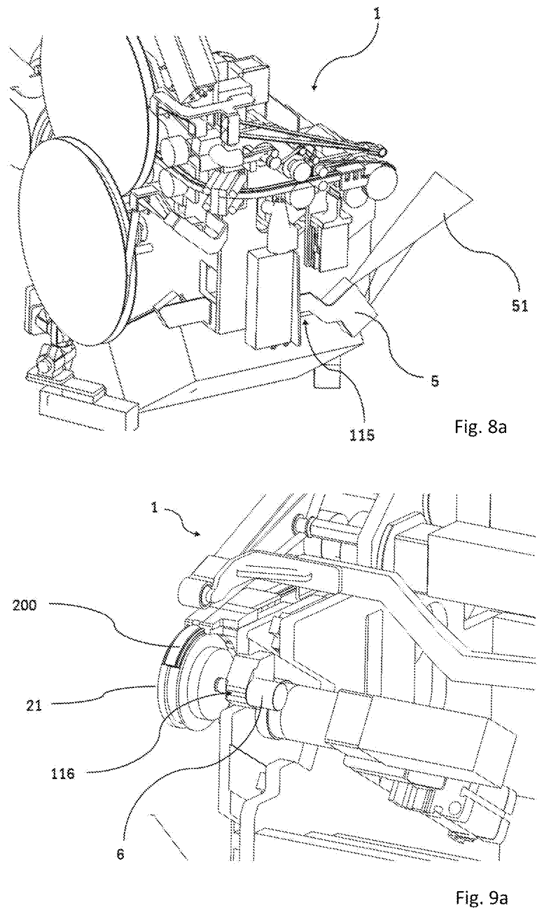

FIG. 9b shows an exemplary embodiment of a sensor unit 6 for checking a pressing force, the sensor unit 6 being configured as a load pin in this exemplary embodiment. Due to the arrangement position 116, illustrated in FIG. 9a, on the base body 10 of the application apparatus 1 being such that a direct connection of the load pin to the pressing unit 21 configured as a pressing roller is realized, it is possible for the pressing force of the pressing unit 21 and thus of the sealing profile 200 to be detected during an application of the sealing profile 200 to a receiving surface of a body component. Advantageously, it is thus possible to detect a reproducibly documented (pressing) force curve, which can in particular be used for process control and error analysis.

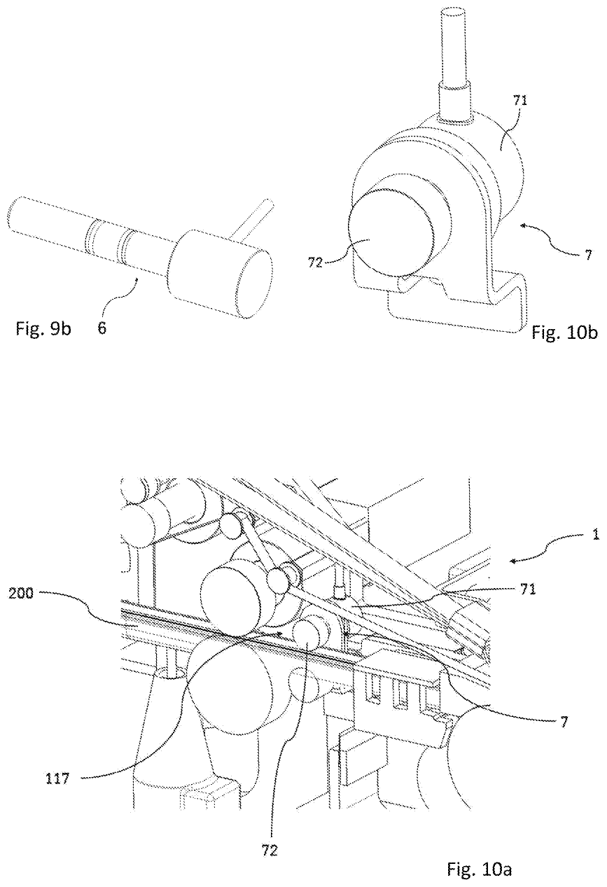

FIG. 10b shows an exemplary embodiment of a sensor unit 7 for measuring a length of the sealing profile 200, said sensor unit in particular determining the length of the sealing profile 200 which a sealing profile 200 to be applied to a receiving surface of a body component is intended to have. To this end, in this exemplary embodiment the sensor unit 7 comprises a rotary encoder 71 and a measuring wheel 72 connected thereto. In this case, the measuring wheel 72 is driven by the conveyance of the sealing profile 200, wherein the revolutions of the measuring wheel 72 are detected by the rotary encoder 71. FIG. 10a shows the arrangement of the sensor unit 7 within the application apparatus 1. In this case, the sensor unit 7 is arranged at the arrangement position 117 which is predetermined for the sensor unit 7. The arrangement position 117 thus makes it possible for the sealing profile length to be able to be detected and stored by means of the sensor unit 7 during the application of the sealing profile 200. In particular, permanent control of the fill level of the storage unit 22 of the sealing profile 200 can thus be performed. Furthermore, the sealing profile consumption can be documented in a simple manner.

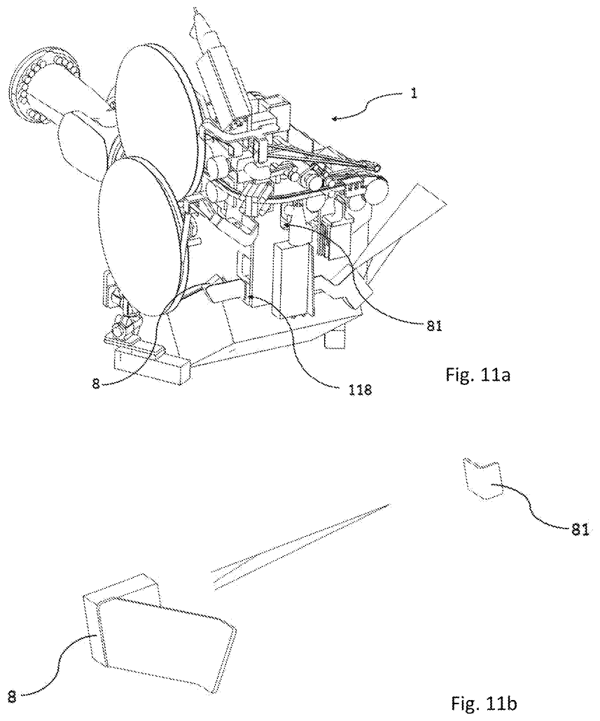

FIG. 11b shows an exemplary embodiment of a sensor unit 8 for measuring a floating position of the pressing unit 21 of the application apparatus 1. In this exemplary embodiment, the sensor unit 8 is configured as a laser distance sensor, wherein the sensor unit 8 in this exemplary embodiment also comprises a shifting plate 81 on which the laser of the laser distance sensor is oriented. In this case, the shifting plate 81 is mechanically coupled to the pressing unit 21, wherein the floating position of the pressing unit 21 can be measured by way of a detected change in position of the shifting plate 81. FIG. 11a shows the arrangement of the shifting plate 81 on an application apparatus 1. In this case, the sensor unit 8 is arranged at the arrangement position 118 of the base body 10 of the application apparatus 1, said arrangement position being assigned to said sensor unit. Advantageously, improved pressing force regulation can be implemented by way of the sensor unit 8. Damage may also be avoided by preventing the end positions of the pressing unit 21 from being reached.

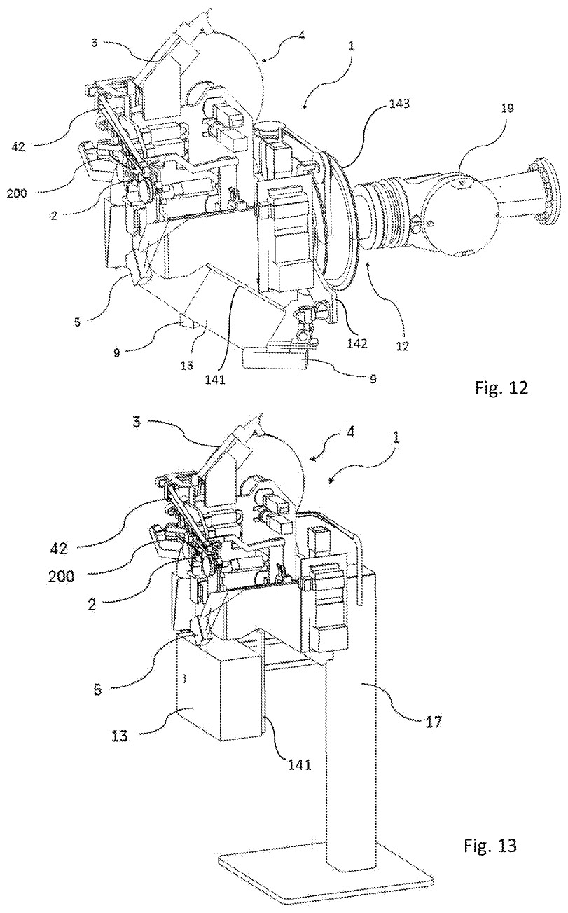

FIG. 12 and FIG. 13 each illustrate a further exemplary embodiment of an application apparatus 1 configured according to the disclosure. In the configuration according to FIG. 12, the base body 10 of the application apparatus 1 is arranged on a robot arm 19 by way of an arrangement interface 12, and in the configuration according to FIG. 13, the base body 10 of the application apparatus 1 is arranged on a station carrier 17 by way of an arrangement interface 12, the station carrier 17 being configured as a mount. In the configuration according to FIG. 12, provision is made for the body component, to which the sealing profile 200 is intended to be applied, to be arranged in a fixed manner, in particular in a hanger, and for the roller head 2 and the further functional units 3, 4, 5 provided by the application apparatus 1 to be guided along the body component by means of the robot arm 19 for execution of the respective station steps. The position of the body component in space relative to the application apparatus 1 is in this case detected by means of the camera units of the sensor unit 9, and the robot arm 19 is controlled correspondingly. By contrast, in the configuration according to FIG. 13, the application apparatus 1 is arranged on the station carrier in a fixed manner and a body component to be processed is guided along the roller head 2 and the further functional units 3, 4, 5 of this application apparatus 1.

These differences between the application apparatuses 1 according to FIG. 12 and FIG. 13 in each case result in certain deviations in the configuration. For instance, the switchgear cabinets 13 of the application apparatuses 1 are for example arranged on the base body 10 of the respective application apparatus 1 in a different manner. In the case of the application apparatus 1 according to FIG. 13, the sensor unit 9 for checking a position of a body component in space is also omitted, since this application apparatus 1 is arranged in a fixed manner. Both application apparatuses 1 are nevertheless based on the same functional modules and can in particular be constructed from the same modular kit.

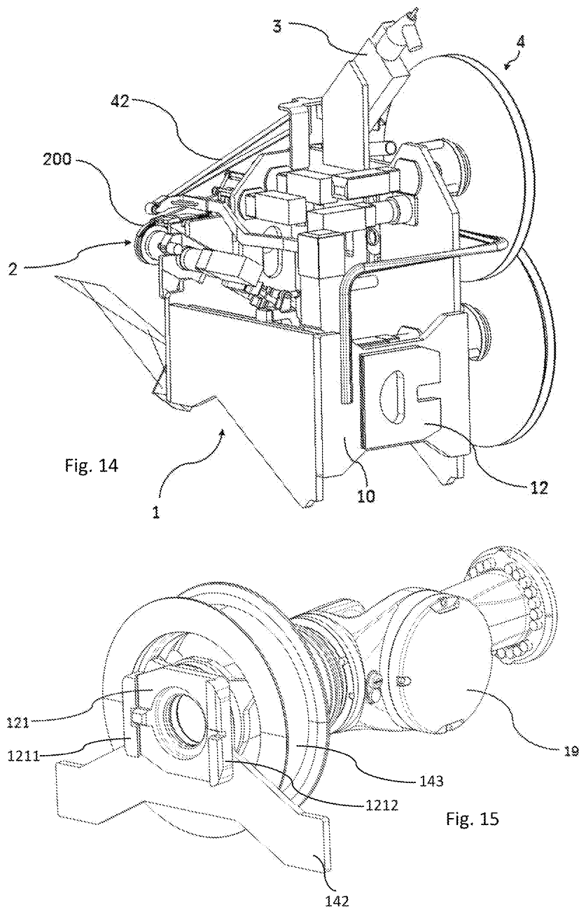

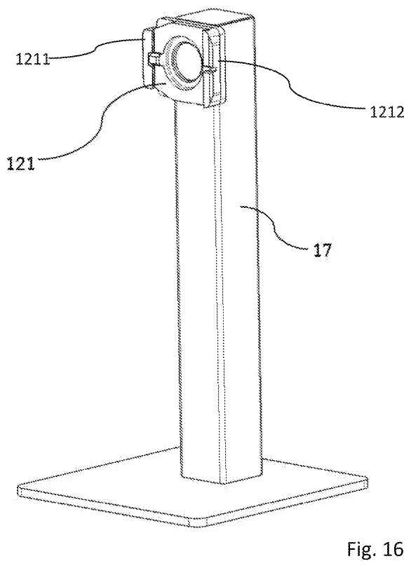

FIG. 14 shows an application apparatus 1 for applying a sealing module 200 to a body component, comprising a base body 10 on which a plurality of functional modules 2, 3, 4 are arranged at predetermined arrangement positions, in particular a roller head 2, a drilling module 3 and a cleaning module 4. The base body 10 of the application apparatus 1 also has an arrangement interface 12 which is configured for arrangement of the base body 10 on a movable robot arm 19, in particular a robot arm 19 as shown in FIG. 15, or on a station carrier 17, in particular on a station carrier as shown in FIG. 16. FIG. 14 shows a particularly advantageous configuration of the arrangement interface 12. In this case, the arrangement interface 12 is partially remote from the base body 10. The arrangement interface 12 has substantially a rectangular periphery, the edges being bevelled towards one side of the arrangement interface 12, as shown in FIG. 14, in particular for a simplified arrangement on a counterpart 121 of the arrangement interface 12. A cutout is also introduced into this side, as also shown in FIG. 14. A counterpart 121 of the arrangement interface 12 is advantageously arranged on the robot arm 19, as shown in FIG. 15. As an alternative thereto, a counterpart 121 of the arrangement interface 12 is advantageously arranged on the station carrier 17, as shown in FIG. 16, a stationary mount being provided as station carrier 17 in FIG. 16. The counterpart 121 is configured to be complementary to the arrangement interface 12, such that the arrangement interface 12 can be connected to the counterpart 121 in a form-fitting manner, wherein a projection of the counterpart engages into the cutout of the arrangement interface 12. Provision is in particular made for the arrangement interface 12 to also be fixed to the counterpart 121 by fastening means, in particular screws. In particular, for this purpose, corresponding bores and/or bolts may also have already been provided on the arrangement interface 12 and/or on the counterpart 121, said bores and/or bolts not being illustrated in FIG. 14 to FIG. 16. As illustrated in FIG. 15 and in FIG. 16, the counterpart 121 of the arrangement interface 12 may have a pair of clamping jaws, by which the arrangement interface 12 is received and fixed. In this exemplary embodiment, the pair of clamping jaws has an adjustable clamping jaw 1211 and a fixed clamping jaw 1212. When the arrangement interface 12 has been received in the pair of clamping jaws, the adjustable clamping jaw 1211 is moved towards the fixed clamping jaw 1212 by way of a screw which is not explicitly illustrated in the figures and fixes the arrangement interface 12 in this way.

The application apparatus 1, as shown in FIG. 14, can then be connected — without needing to make any changes to the application apparatus 1 shown in FIG. 14 — either to the robot arm 19 or to the station carrier 17 by way of the arrangement interface 12. Advantageously, an arrangement of the application apparatus 1 on a robot arm 19 or on a station carrier 17 can be realized by means of a first set of adaptation parts provided for an arrangement on a robot arm 19 or, respectively, by means of a second set of adaptation parts provided for an arrangement on a station carrier 17. These adaptation parts, which may for example relate to the receptacle 141 of a switchgear cabinet 13, or a receptacle 142 for the sensor units 9 for checking a position of a body component in space and/or a sealing drum 143 in which the sealing profile is provided in stored form, are advantageously arranged on the application apparatus 1 in a supplementary manner, in order to be able to adapt the application apparatus 1 even more effectively to the respective manner of arrangement. However, such an adaptation is not necessary. In FIG. 12 and FIG. 13, the respective receptacle 141 for the switchgear cabinet 13 is only designed differently to improve the respective handling. The different configuration of the receptacle 141 of the switchgear cabinet is not necessary.

Advantageously, adaptations to the application apparatus 1 for a stationary use or for a robot-guided use can be performed in a standardized manner, and advantageously as separate assemblies, using the sets of adaptation parts. In this case, the application apparatus 1, in particular the base body 10 of the application apparatus 1, is advantageously already configured for arrangement both of the parts of the first set of adaptation parts and of the parts of the second set of adaptation parts. This means that in particular required bores, cutouts and/or holders for the parts of these sets are already comprised by the application apparatus 1 or the base body 10 of the application apparatus 1. Provision is in particular made for the first set of adaptation parts to comprise at least one of the parts mentioned below: stationary mount; switch box connection;

sealing drum. Furthermore, provision is in particular made for the second set of adaptation parts to comprise at least one of the parts mentioned below: robot connection; switch box connection; sealing drum.

The exemplary embodiments illustrated in the figures and explained in conjunction therewith serve to explain the disclosure and have no limiting effect thereon.

### List of Reference Signs

1 Application apparatus

2 Roller head

21 Pressing unit

22 Storage unit

23 Roll for guiding the sealing profile 200

24 Drive unit for driving rolls (23)

3 Drilling unit

31 Drill bit of the drilling unit (3)

32 Suction-removal hood of the drilling unit (3)

33 Drilling axis

331 Drilling axis with adjusted orientation

4 Cleaning unit

41 Cleaning roll

42 Cleaning belt

43 Roll for providing clean cleaning belt (42)

44 Roll for receiving used cleaning belt (42)

45 Drive unit for roll

46 Drive for the carriage (47) for a lateral movement travel

47 Carriage

48 Pressing cylinder for the cleaning roll (41)

5 Sensor unit for checking the position of the sealing profile applied to a body component

51 Detection region of the sensor unit (5)

6 Sensor unit for checking a pressing force

7 Sensor unit for measuring a sealing profile length

71 Rotary encoder

72 Measuring wheel

8 Sensor unit for measuring a floating position of a pressing unit

81 Shifting plate

9 Sensor unit for checking a position of a body component in space

91 Holding apparatus

10 Base body

101 Cutout

102 Projection

103 Bore

11# Arrangement position (“#” stands for the reference sign of a respective module)

1131 Arrangement position for a drilling unit (3) for drilling during the application

1132 Arrangement position for a drilling unit (3) for drilling after the application

114 Arrangement position for a cleaning unit (4)

115 Arrangement position for a sensor unit (5) for checking the position of the sealing profile applied to a body component

116 Arrangement position for a sensor unit (6) for checking a pressing force

117 Arrangement position for a sensor unit (7) for measuring a sealing profile length

118 Arrangement position for a sensor unit (8) for measuring a floating position of a pressing unit (21)

119 Arrangement position for a sensor unit (9) for checking a position of a body component in space

1115 Arrangement position for a separating unit (15)

12 Arrangement interface

121 Counterpart of the arrangement interface (12)

1211 Adjustable clamping jaw

1212 Fixed clamping jaw

13 Switchgear cabinet

141 Receptacle for switchgear cabinet

142 Receptacle for sensor units 9

143 Sealing drum

15 Separating unit

17 Station carrier

19 Robot arm

200 Sealing profile

What is claimed is:

1. An application apparatus for applying a sealing profile to a body component, comprising:
a roller head configured to, as a first station step, apply the sealing profile to a receiving surface of the body component, including a drilling unit having a drill bit,
wherein the drilling unit is configured to, as further station step, drill holes into the sealing profile by means of the drill bit.

2. The application apparatus of claim 1, wherein the drilling unit is assigned to an arrangement position which defines a drilling of the sealing profile as further station step prior to an application of the sealing profile.

3. The application apparatus of claim 1, wherein the drilling unit is assigned to an arrangement position which defines a drilling of the sealing profile as further station step during an application of the sealing profile.

4. The application apparatus of claim 1, wherein the drilling unit is assigned to an arrangement position which defines a drilling of the sealing profile as further station step after an application of the sealing profile.

5. The application apparatus of claim 1, wherein the application apparatus is assigned a control unit, wherein the control unit is configured to control the roller head and the drilling unit.

6. The application apparatus of claim 1, wherein the drill bit of the drilling unit is oriented along a drilling axis, wherein the drilling axis of the drill bit can be adjusted by means of an actuator unit of the application apparatus.

7. The application apparatus of claim 6, wherein the drilling axis of the drill bit can be adjusted in a first spatial direction (X) and/or in a second spatial direction (Y) and/or in a third spatial direction (Z).

8. The application apparatus of claim 1, wherein the drilling unit includes a suction-removal unit which is configured for suction removal of chips produced during the drilling of the sealing profile.

9. The application apparatus of claim 1, wherein the drilling unit comprises at least one sensor unit which is configured to monitor a drilling operation carried out by the drill bit of the drilling unit.

10. The application apparatus of claim 1, further comprising an arrangement interface by way of which the application apparatus is arranged on a movable robot arm or on a station carrier.
